(19) United States
(12) Patent Application Publication
(10) Pub. No.: US 2006/0104613 A1
(43) Pub. Date: May 18, 2006

(54) Video recording/reproducing apparatus and video recording control method

(75) Inventor: Hideo Kunii, Fukaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/273,401

(22) Filed: Nov. 15, 2005

(30) Foreign Application Priority Data
Nov. 15, 2004 (JP) 2004-330946

(51) Int. Cl. H04N 5/76

(52) U.S. Cl. 386/94; 360/60; 380/201; 380/203

(57) ABSTRACT

A video recording/reproducing apparatus comprises a mode setting unit which specifies first or second mode, a first programmed recording unit which inhibits video recording/reproduction until a programmed start time and records a programmed broadcast program from the programmed start time to a programmed end time in the first mode, and a second programmed recording unit which records an identification signal at a recording start position on a recording medium, reproduces the identification signal on the recording medium at a time which is ahead by a predetermined time from the programmed start time to cue the recording start position, and records the programmed broadcast program from the programmed start time to the programmed end time in the second mode.

### CROSS-REFERENCE TO RELATED APPLICATIONS

This application is based upon and claims the benefit of priority from prior Japanese Patent Application No. 2004-330946, filed Nov. 15, 2004, the entire contents of which are incorporated herein by reference.

### BACKGROUND OF THE INVENTION

1. Field of the Invention

The present invention relates to a video recording/reproducing apparatus having a programmed recording function, and a video recording control method.

2. Description of the Related Art

In general, a video recording/reproducing apparatus such as a video cassette recorder has a programmed recording function. A video recording start time, a video recording end time, a channel and others are stored in a programming information storage device in advance. When a recording start position is cued after loading a video cassette in a video cassette recorder and a timer on/off button is pressed to enter a timer standby mode, a main power supply is turned off. Therefore, when the timer standby mode is set, a regular operation is inhibited, and any video recording/reproducing operation cannot be accepted until a video recording start time. This avoids a shift of a cued recording start position obtained by performing cue for programmed recording and then effecting a reproducing/recording operation. However, in the timer standby mode, the video cassette recorder cannot be used at all until a programmed time, which is inconvenient.

It is to be noted that, when the timer on/off button is pressed in the timer standby mode, the timer standby mode is cleared, the main power supply is turned on, and the video recording/reproducing operation is enabled. However, as a result of reproduction, there is a possibility that a cue position is shifted and a reserved program is overwritten on a recorded part. Further, in particular, there is another possibility that any other person records a different program on the same tape so that a residual quantity of the tape becomes insufficient, which disables video recording of a reserved program. Furthermore, when a user forgets to press the timer on/off button to return to the timer standby mode after clearing the timer standby mode, a long-awaited reservation comes to nothing.

On the other hand, a video cassette recorder by which a video recording position on a tape can be freely set has been developed (see, e.g., Japanese Patent Application KOKAI Publication No. 6-215441 (paragraph 0008, FIG. 1). Here, in order to freely set a video recording position on a tape and a video recording order, a counter which counts a traveling length of the tape is provided, and a traveling distance of the tape is indicated by a video recording time value when recording a video on the tape rather than a numeric value. When programming video recording, a desired recording start position (a video recording time value) is also input (stored) in addition to a video recording start time, a video recording end time and a channel. A tape is set to a leading position before starting video recording, the tape is fast-forwarded when the video recording start time is reached so that tape is advanced to a time corresponding to a recording start position, and then video recording is started. Simultaneously with start of video recording, data at the recording start position defined by VISS is recorded on the tape. When video recording is terminated, the tape is rewound to the leading position. When a video recording start time of the next reserved program is reached, the tape is fast-forwarded to be set to a time corresponding to the recording start position, and then video recording is started. This operation is repeated.

However, this publication intends to shift a video recording order forward and backward, a plurality of TV dramas which come on the air everyday are divided in accordance with each title on one tape, and daily video recording of each title is continuously carried out. In this reference is required an operation of certainly rewinding a tape to a leading position upon termination of programmed recording and advancing the tape to a specified recording start position at the time of start of programmed recording, thereby requiring a troublesome effort. Furthermore, this reference does not disclose a concept that a video recording/reproducing operation is temporarily allowed after the timer standby mode is set.

As described above, in the conventional programmed recording function, after performing cue in a storage medium to set the timer standby mode, the main power supply is turned off, a regular operation is inhibited, and a video recording/reproducing operation is not accepted until a video recording start time is reached. Therefore, convenience is sacrificed.

### BRIEF SUMMARY OF THE INVENTION

It is an object of the present invention to provide a video recording/reproducing apparatus and a video recording control method capable of starting video recording from a cue position when a programmed time is reached even if video recording/reproduction is performed during a standby mode of programmed recording.

According to an embodiment of the present invention, a video recording/reproducing apparatus comprises:

a mode setting unit which specifies first or second mode;

a first programmed recording unit which inhibits video recording/reproduction until a programmed start time and records a programmed broadcast program from the programmed start time to a programmed end time in the first mode; and

a second programmed recording unit which records an identification signal at a recording start position on a recording medium, reproduces the identification signal on the recording medium at a time which is ahead by a predetermined time from the programmed start time to cue the recording start position, and records the programmed broadcast program from the programmed start time to the programmed end time in the second mode.

According to another embodiment of the present invention, a video recording/reproducing apparatus comprises:

a main body having a processing unit which generates an index signal corresponding to a reserved program, a tape drive unit which records a broadcast signal and the index signal on a magnetic tape, and a video recording/reproduction control unit;

a main power supply for the main body;

a memory which stores reserved recording information involving the index signal;

a timer which clocks a time;

a user operable member which instructs reserved recording standby;

a specifying unit which specifies whether an instruction from the operable member is valid or invalid;

a standby controller which turns off the main power supply until a reserved recording start time when the user operable member is operated in a state where an instruction from the operable member is valid, records an index signal corresponding to a first reserved program on the magnetic tape when the user operable member is operated in a state where an instruction from the operable member is invalid, and reproduces the index signal from the magnetic tape at a time which is ahead by a predetermined time from the reserved recording start time to cue a recording start position; and

a reserved recording unit which records program information corresponding to the reserved recording information on the magnetic tape when the reserved recording time is reached.

According to another embodiment of the present invention, a video recording control method comprises:

specifying first or second mode;

inhibiting video recording/reproduction until a programmed start time and recording a programmed broadcast program from the programmed start time to a programmed end time in the first mode; and

recording an identification signal at a recording start position on a recording medium, reproducing the identification signal on the recording medium at a time which is ahead by a predetermined time from the programmed start time to cue the recording start position, and recording the programmed broadcast program from the programmed start time to the programmed end time in the second mode.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a block diagram showing a configuration of a video recording/reproducing apparatus according to an embodiment of the present invention;

FIGS. 2A and 2B are views illustrating positional information of a VISS/VASS mode used in the embodiment, in which FIG. 2A schematically shows a recorded signal and FIG. 2B shows a reproduction waveform of a control pulse; and

FIG. 3 is a flowchart showing an operation procedure of a programmed recording operation according to the embodiment.

### DETAILED DESCRIPTION OF THE INVENTION

An embodiment of a video recording/reproducing apparatus according to the present invention will now be described hereinafter with reference to the accompanying drawings.

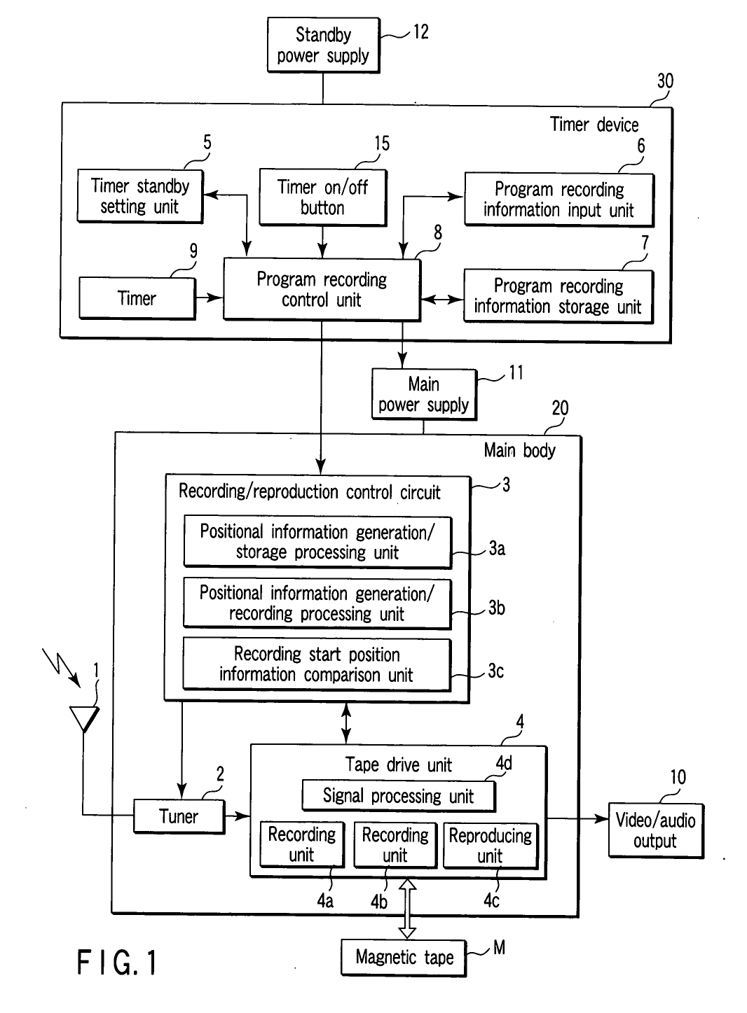

FIG. 1 is a schematic structural view showing a video recording/reproducing apparatus according to a first embodiment. Here, a description will be given on a video cassette recorder as an example, but the present invention is not limited thereto. This apparatus mainly includes a main body 20 and a timer device 30, the timer device 30 is operated by a standby power supply 12, and the main body 20 is operated by a main power supply 11. The main power supply 11 is controlled by a programmed recording control unit 8 in the timer device 30. In a timer standby mode, the main power supply 11 is turned off, and the main body 20 is inoperative. The standby power supply 12 can be turned on even in the timer standby mode.

The main body 20 comprises a tuner 2 connected with an antenna 1, a recording/reproducing control circuit 3 which controls each portion in the main body 20, and a tape drive unit 4 which performs video recording, recording and reproduction of a magnetic tape M. An output from the tape drive unit 4 is supplied to a video/audio output 10 (e.g., a CRT monitor, an LCD panel or a speaker).

The recording/reproducing control circuit 3 includes a positional information generation/storage processing unit 3a which generates first positional information corresponding to programmed recording information and stores it in a programmed recording information storage unit 7 in the timer device 30, a positional information generation/recording processing unit 3b which generates second positional information corresponding to the first positional information and records it on the magnetic tape M, and a recording start position information comparison processing unit 3c which compares the first positional information with the second positional information and outputs a matching signal.

The tape drive unit 4 comprises a video recording unit 4a which records a video/audio signal on a video/audio track of the magnetic tape M, a recording unit 4b which records recording start position information defined by a VISS/VASS scheme on a control track of the magnetic tape M, a reproducing unit 4c which reproduces information recorded by the video recording unit 4a and the recording unit 4b, and a signal processing unit 4d.

VISS is an abbreviation of VHS (a registered trademark) Index Search System, and it is a system which records an index signal on a control track of the tape by varying a duty ratio of a control pulse. A signal can be recorded during both video recording and reproduction, and the signal can be erased any number of times. A predecessor of this concept is an index search system based on a beta (a registered trademark) scheme.

VASS is an abbreviation of VHS (a registered trade mark) Address Search System, and it records a signal on a control track by varying a duty ratio of a control pulse like VISS. Although the index signal based on VISS simply indicates a change of a duty ratio of a control pulse, the index signal based on VASS can indicate a position of a change of a duty ratio of a control pulse as different from the former. According to VASS, it is possible to record up to a numeric of four digits. As a result, cueing of a tape can be freely performed.

When the timer standby mode is set, the timer device 30 turns off the main power supply 11 in order to disable an operation of the main body 20, and turns on the main power supply 11 in order to enable an operation of the main body 20 when a programmed recording start time is reached, thereby effecting programmed recording. The timer device 30 includes a timer on/off button 15 which specifies transition to/clearing of the timer standby mode, a timer standby setting unit 5 which sets an operation of the timer on/off button 15 to “valid”/“invalid”, a programmed recording information input unit 6 which inputs programmed recording information such as channel and a broadcast scheduled time (a start time and an end time) of a TV broadcast program which should be reserved for video recording, a programmed recording information storage unit 7 which stores input programmed recording information or recording start position information, a timer 9 which clocks a time, and a programmed recording control unit 8 which is connected with each of these portions to control them and also connected with the main power supply 11 and the video recording/reproduction control circuit 3 to control them.

An operation of the embodiment will now be described. After cue of the magnetic tape M is performed to a recording start position, when a channel and a broadcast scheduled time (a start time and an end time) of a TV broadcast program which should be recorded are set, a video recording system which performs programmed recording of a broadcast program controls a video recording operation in such a manner that the main power supply 11 is turned on at a video recording start time, a program broadcasted in a predetermined TV channel is recorded for a programmed time and the main power supply 11 is turned off at a video recording end time.

When the broadcast is received through a radio wave, broadcasted information is input to the main body 20 of the video recording/reproduction apparatus from the antenna 1. The information input from the antenna 1 is tuned with respect to a frequency of each broadcast station by the tuner 2, thereby obtaining broadcast content (pictures, sounds, audio mode information, text broadcasting and others) from a specific broadcast station. Such information is converted into information which should be recorded on the tape by the signal processing unit 4d, and recorded on the magnetic tape M through the video recording unit 4a. A command of video recording with respect to the tape drive unit 4 is issued by a user utilizing a video recording button (not shown) in the video recording/reproducing apparatus. Although the video recording button can be provided on an apparatus front surface, it is usually provided on a remote controller (not shown). However, in case of so-called programmed recording that a user sets the above-described video recording in advance, the programmed recording control unit 8 instructs video recording with respect to the tape drive unit 4 at a predetermined time. The video recording button is also connected with the programmed recording control unit 8, and an instruction from the video recording button is input to the programmed recording control unit 8 to control the signal processing unit 4d through the recording/reproducing control circuit 3, whereby the signal processing unit 4d is set to a video recording state.

Moreover, usually, a helical scanning type video cassette recorder records a control pulse for a servo signal on a linear track. In this case, a signal from the recording/reproducing control circuit 3 is received by a servo IC to create a control pulse, and the created control pulse is recorded through the recording unit 4b. Although signals received in the video recording/reproducing apparatus are a video/audio signal and a character signal alone, but there are a VISS signal and a VASS signal which are recorded on the magnetic tape besides the video/audio signal. The VISS signal and the VASS signal are recorded on the control track. In regard to these signals, the duty of a control pulse (the duty ratio is 50 percent) is shifted from 50 percents to record signals “1” and “0”, and a code is serially recorded as binary digits.

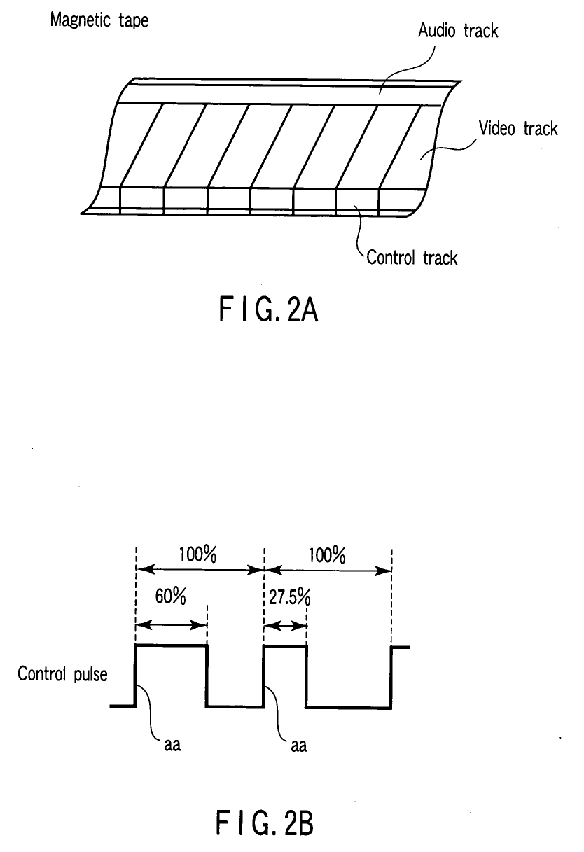

In general, a traveling time (a recording or reproducing time) of the magnetic tape is detected during traveling by using time information on the tape recorded in a magnetic tape longitudinal direction by the recording unit 4b. FIG. 2A is a view schematically showing a recording track on the magnetic tape M according to the embodiment. The magnetic tape M having a signal recorded thereon has an audio track, a video track and a control track. An audio signal is recorded on the audio track by an audio head (not shown), a video signal is recorded on the video track by a cylinder head (not shown), and a control pulse is recorded on the control track by a control head (not shown).

FIG. 2A schematically shows a recorded signal. The cylinder head records a video signal while rotating at a speed of 30 revolutions per second, and one control pulse is recorded every time the cylinder head makes one revolution. FIG. 2B shows a reproduction waveform of the control pulse. During tape reproduction, a tape traveling speed is controlled so that a cycle of the control pulse becomes always fixed. Information required as servo information is a timing of a leading edge aa only.

In a home-use video cassette recorder adopting a VHS (a registered trademark) scheme, there are conventionally VISS and VASS schemes which records cue information or the like of a program as means for recording information other than servo information by varying a duty ratio of a control pulse. In the VASS scheme, information is recorded by varying a duty ratio of a control pulse in order to use a trailing edge which is unnecessary as servo information. For example, a control pulse having a duty ratio of 60% means “0”, whilst a control pulse having a duty ratio of 27.5% means “1”, and cue information, program information or the like of a program is recorded based on a combination of these control pulses.

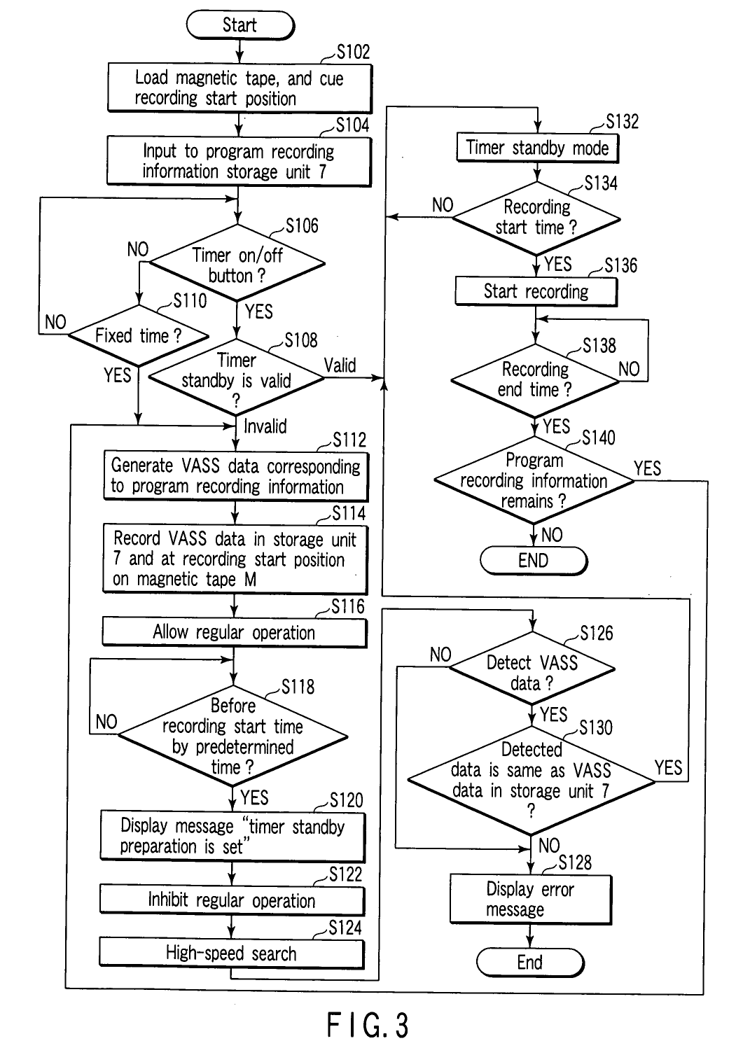

FIG. 3 is a flowchart showing an operation procedure of programmed recording in the video recording/reproducing apparatus according to the embodiment. In order to perform programmed recording of a broadcast program, programmed recording program information is first input from the programmed recording information input unit 6, and the input information is stored in the programmed recording information storage unit 7. The number of reserved programs is not restricted to one, a plurality of programs can be reserved. In a prior art, in case of executing programmed recording, the timer on/off button 15 must be pressed to enter the timer standby mode in order to prevent a cue position from varying after loading a video cassette and then performing cue of a recording start position. In the timer standby mode, the main power supply 11 is turned off. Since the main power supply 11 remains off until a programmed recording start time comes, a reproducing operation or a video recording operation is inhibited during this off period. Therefore, a cue position of the tape can be prevented from being shifted. However, since certainly setting the timer standby mode after loading the cassette may be inconvenient in some cases, this embodiment also supports a mode which enables a video recording/reproducing operation in a state where a cue position is saved without turning off the main power supply 11 until a programmed recording start time comes after loading the cassette and performing cue (this mode will be referred to as an auto mode hereinafter). That is, a positional signal is first recorded at a cue position of the magnetic tape. Then, even if video recording/reproduction is carried out and the cue position is thereby shifted before the programmed recording is started, the cue position (a specified recording start position) is retrieved when programmed recording is started, and the tape is set to the retrieved position to thereafter commence video recording.

Specifically, at step S102, the video cassette is loaded in the video recording/reproducing apparatus, and cueing of a recording start position is carried out while reproducing the magnetic tape M to conform recorded contents.

At step S104, programmed recording information (a channel and a broadcast scheduled time (a start time and an end time) of a TV broadcast program which should be reserved for video recording) is input by using the programmed recording information input unit 6. The input programmed recording information is stored in the programmed recording information storage unit 7 under control of the programmed recording control unit 8. Table 1 shows an example of content of the programmed recording information storage unit 7. A VASS signal is stored in the auto mode as will be described later.

TABLE 1

| | | Video | | |
|---|---|---|---|---|
| | Video recording | recording end | | |
| | start time | time | Channel | VASS |
| 1 | 10:00, Oct. 10 | 10:30, Oct. 10 | 1 | VASS₁ |
| 2 | 21:00, Oct. 11 | 22:00, Oct. 11 | 3 | VASS₂ |
| 3 | 12:00, Oct. 14 | 12:30, Oct. 14 | 4 | VASS₃ |
| 4 | 07:00, Oct. 20 | 08:55, Oct. 20 | 6 | VASS₄ |
| . . . | . . . | . . . | . . . | . . . |

It is to be noted that step S102 and step S104 may be executed in a reverse order. Further, input of the programmed recording information at step S104 may be previously executed before starting this flowchart.

As described above, in this embodiment, an operation of the timer on/off button 15 which specifies transition to/clearing of the timer standby mode can be selectively invalidate. This selection is previously performed together with a setting of a tape length (a recording time), an on/off setting of noise reduction and an on/off setting of commercial auto skip by using, e.g., an on-screen menu (a screen for various settings of VTR). When the button 15 is pressed in a state where an operation of the timer on/off button 15 is invalid, the auto mode is set.

At step S106, it is determined whether or not the timer on/off button 15 is operated. If the button 15 is operated, it is determined whether or not an operation of the timer on/off button 15 is set to a valid state at step S108. If the operation is disabled, the timer standby mode is set at step S132. In the timer standby mode, the main power supply 11 is turned off.

At step S134, the programmed recording control unit 8 determines whether a clocked time of the timer 9 has reached a programmed recording start time stored in the programmed recording information storage unit 7. Step S132 is repeated until a result of the determination becomes YES (reaching the programmed recording start time).

When the programmed recording start time is reached, video recording of a broadcast program on a channel stored in the programmed recording information storage unit 7 is started at step S136.

At step S138, the programmed recording control unit 8 determines whether or not a clocked time of the timer 9 has reached a programmed recording end time stored in the programmed recording information storage unit 7. Video recording continues until a result of the determination becomes YES (reaching the programmed recording end time).

When the programmed recording end time is reached, video recording is terminated, the programmed recording program information is erased, and it is determined at step S140 whether or not programmed recording information which is unrecorded remains in the programmed recording information storage unit 7. If the information does not remain, the operation is terminated. If the information remains, the routine returns to step S112. Processing at step S112 and subsequent steps is processing in the auto mode.

If an operation of the timer on/off button 15 is set to an invalid state at step S108, the routine advances to step S112, and the auto mode is set.

If an operation of the timer on/off button 15 is not detected at step S106, it is determined at step S110 whether or not a fixed time has elapsed after completion of input of the programmed recording information at step S104. If a lapse of the fixed time is detected, the routine proceeds to step S112, and the auto mode is set.

At step S112, identification information corresponding to programmed recording information having an earliest video recording start time, e.g., VASS data is generated.

At step S114, this VASS data is input to the programmed recording control unit 8 based on a command from the positional information generation/storage processing unit 3a, and stored in the programmed recording information storage unit 7 as shown in Table 1. Furthermore, this VASS data is input to the recording unit 4b of the tape drive unit 4 and recorded on the magnetic tape M based on a command from the positional information generation/recording processing unit 3b. Therefore, the VASS data is recorded at a cue position, and the corresponding VASS data is stored in the programmed recording information storage unit 7.

At step S116, a regular operation (video recording/reproduction) is allowed.

At step S118, the programmed recording control unit 8 determines whether a clocked time of the timer 9 has reached a time which is ahead by a predetermined time (e.g., five minutes) from a programmed recording start time stored in the programmed recording information storage unit 7. Step S118 is repeated until a result of the determination becomes YES (reaching the time which is ahead the predetermined time from the programmed recording start time).

When the time which is ahead the predetermined time from the programmed recording start time is reached, a message “timer standby preparation begins (therefore, a regular operation is inhibited)” is notified at step S120.

At step S122, the regular operation is inhibited, and preparation for the timer standby mode begins.

Since the regular operation is allowed in the auto mode, there is a possibility that the tape travels during this period and a cued recording start position obtained is thereby shifted. Therefore, at step S124, the tape drive unit 4 detects VASS data by high-speed search in order to perform cueing of the recording start position.

At step S126, it is determined whether or not the VASS data is detected by this high-speed search. If it is not detected, the tape may be possibly replaced, or data may be possibly overwritten on the recording start position. Therefore, an error message is displayed at step S128 and the operation is terminated.

If the VASS data is detected, it is determined at step S130 whether or not the detected VASS data matches with any VASS data stored in the programmed recording information storage unit 7. If there is no matching data, an error message is displayed at step S128 and the routine is terminated.

If there is matching data, the timer standby mode is set at step S132. The subsequent operation is as described above.

As mentioned above, according to the first embodiment, it is possible to realize the auto mode in which a cue position is saved in the programming standby state after loading and cueing the tape and the video recording/reproducing operation is enabled in the standby state. Since a cue position is retrieved before starting programmed recording and the tape is rewound to the retrieved position to thereafter start video recording, video recording can be appropriately performed from a recording start position even if the tape travels in the standby state. This auto mode can be specified by operating the timer on/off button 15 in a state where the operation of the timer on/off button 15 which specifies transition to/clearing of the timer standby mode is set to be invalid by the timer standby setting unit 5.

When the timer on/off button 15 is not operated for a fixed time after loading and cueing the tape/inputting programmed recording information, the auto mode is automatically set.

Moreover, since the VASS signal is directly recorded at a specified position on the tape while a user is performing playback in the auto mode, a video recording position can be readily set in a short time. As a result, a video can be freely reproduced from timer standby setting to start of video recording, thereby enabling elimination of inconvenience which is impossible in the prior art.

Additionally, since a recording start position at which the VASS signal is recorded is specified by user, erroneous overwriting of an existing video recording tape can be avoided.

Since a cue position is saved in the programmed recording standby state, video recording/reproduction can be performed in the standby state, and video recording can be properly started from the cue position when a programmed time is reached.

According to the embodiment, there is provided a video recording/reproducing apparatus comprising:

a first programmed recording unit which inhibits video recording/reproduction until a programmed start time and records a programmed broadcast program from the programmed start time to a programmed end time;

a selector which selects whether the first programmed recording unit is allowed to operate; and

a specifying unit which specifies whether an operation of the selector is valid or invalid.

The video recording/reproducing apparatus further comprises a second programmed recording unit which records an identification signal at a recording start position on a recording medium, reproduces the identification signal on the recording medium at a time ahead by a predetermined time from the programmed start time to cue the recording start position, and records a programmed broadcast program from the programmed start time to a programmed end time when the selector selects that the first programmed recording unit is allowed to operate in a state where the specifying unit specifies that an operation of the selector is invalid.

In the video recording/reproducing apparatus, the identification signal differs depending on a plurality of programmed broadcast programs.

According to the embodiment, there is provided a video recording/reproducing apparatus comprising:

a memory which stores a programmed start time, a programmed end time and programmed channel information;

a recording unit which records an identification signal at a recording start position on a recording medium;

a reproducing unit which reproduces the identification signal on the recording medium at a time which is ahead by a predetermined time from the programmed start time stored in the memory to cue the recording start position;

a programmed recording unit which records a broadcast program corresponding to the programmed channel information from the programmed start time to the programmed end time stored in the memory;

an inhibiting unit which inhibits video recording/reproduction until the programmed start time stored in the memory;

a specifying unit which specifies whether an inhibition of the inhibiting unit is valid or invalid; and

a controller which operates the identification signal recording unit, the reproducing unit and the programmed recording means when the specifying means specifies that the inhibition of the inhibiting unit is invalid, and operates the inhibiting means and the programmed recording means when the specifying means specifies that the inhibition of the inhibiting unit is valid.

According to the embodiment, there is provided a video recording control method comprising:

storing a programmed start time, a programmed end time and programmed channel information;

recording an identification signal at a recording start position on a recording medium;

reproducing the identification signal on the recording medium at a time which is ahead by a predetermined time from the programmed start time to cue the recording start position;

recording a broadcast program corresponding to the programmed channel information from the programmed start time to the programmed end time;

inhibiting video recording/reproduction until the programmed start time;

specifying whether the inhibition of the inhibiting step is valid or invalid; and

operating the identification signal recording step, the reproducing step and the programmed recording step when the specifying step specifies that the inhibition of the inhibiting step is invalid, and operating the inhibiting step and the programmed recording step when the specifying step specifies that the inhibition of the inhibiting step is valid.

According to the embodiment, there is provided a video recording control method of a video recording/reproducing apparatus comprising:

a main body having a processing unit which generates an index signal corresponding to a reserved program, a tape drive unit which records a broadcast signal and the index signal on a magnetic tape, and a video recording/reproduction control unit;

a main power supply for the main body;

a memory which stores reserved recording information involving the index signal;

a timer which clocks a time;

a user operable member which instructs reserved recording standby;

a specifying unit which specifies whether an instruction from the operable member is valid or invalid;

a standby controller which records program information corresponding to the reserved recording information on the magnetic tape when a reserved recording start time is reached, the method comprising:

turning off the main power supply until a reserved recording start time when the user operable member is operated in a state where an instruction from the operable member is valid;

recording an index signal corresponding to a first reserved program on the magnetic tape when the user operable member is operated in a state where an instruction from the operable member is invalid; and

reproducing the index signal from the magnetic tape at a time which is ahead by a predetermined time from the reserved recording start time to cue a recording start position.

The video recording control method further comprises:

outputting an error message when the index signal corresponding to the reserved program cannot be reproduced.

The video recording control method further comprises:

recording an index signal corresponding to the next reserved program on the magnetic tape when recording of the program information corresponding to the reserved recording information is terminated.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, although the above describes the VASS signal as a positional signal, it is possible to use a VISS signal or any other signal which can be discriminated from a control pulse.

What is claimed is:

1. A video recording/reproducing apparatus comprising:
a mode setting unit which specifies first or second mode;
a first programmed recording unit which inhibits video recording/reproduction until a programmed start time and records a programmed broadcast program from the programmed start time to a programmed end time in the first mode; and
a second programmed recording unit which records an identification signal at a recording start position on a recording medium, reproduces the identification signal on the recording medium at a time which is ahead by a predetermined time from the programmed start time to cue the recording start position, and records the programmed broadcast program from the programmed start time to the programmed end time in the second mode.

2. The video recording/reproducing apparatus according to claim 1, wherein the identification signal differs depending on a plurality of programmed broadcast programs.

3. A video recording/reproducing apparatus comprising:
a main body having a processing unit which generates an index signal corresponding to a reserved program, a tape drive unit which records a broadcast signal and the index signal on a magnetic tape, and a video recording/reproduction control unit;
a main power supply for the main body;
a memory which stores reserved recording information involving the index signal;
a timer which clocks a time;
a user operable member which instructs reserved recording standby;
a specifying unit which specifies whether an instruction from the operable member is valid or invalid;
a standby controller which turns off the main power supply until a reserved recording start time when the user operable member is operated in a state where an instruction from the operable member is valid, records an index signal corresponding to a first reserved program on the magnetic tape when the user operable member is operated in a state where an instruction from the operable member is invalid, and reproduces the index signal from the magnetic tape at a time which is ahead by a predetermined time from the reserved recording start time to cue a recording start position; and
a reserved recording unit which records program information corresponding to the reserved recording information on the magnetic tape when the reserved recording time is reached.

4. The video recording/reproducing apparatus according to claim 3, wherein, when the index signal corresponding to the reserved program cannot be reproduced, the reserved recording unit outputs an error message.

5. The video recording/reproducing apparatus according to claim 3, wherein, when recording of the program information corresponding to the reserved recording information is terminated, the reserved recording unit records an index signal corresponding to the next reserved program on the magnetic tape.

6. A video recording control method comprising:
specifying first or second mode;
inhibiting video recording/reproduction until a programmed start time and recording a programmed broadcast program from the programmed start time to a programmed end time in the first mode; and
recording an identification signal at a recording start position on a recording medium, reproducing the identification signal on the recording medium at a time which is ahead by a predetermined time from the programmed start time to cue the recording start position, and recording the programmed broadcast program from the programmed start time to the programmed end time in the second mode.
